(19) United States
(12) Patent Application Publication
(10) Pub. No.: US 2009/0115609 A1
(43) Pub. Date: May 7, 2009

(54) Transaction originating proximate position unattended tracking of asset movements with or without wireless communications coverage

(76) Inventor: Frederick Michael Weaver, Huntersville, NC (US)

Correspondence Address: FREDERICK M. WEAVER, 8916 HUNTER'S POINTE DRIVE, HUNTERSVILLE, NC, 28078, US

(21) Appl. No.: 12/220,766

(22) Filed: Jul. 28, 2008

Related U.S. Application Data
(60) Provisional application No. 60/962,280, filed on Jul. 28, 2007.

(51) Int. Cl. G08B 13/14

(52) U.S. Cl. 340/572.1

(57) ABSTRACT

An asset in a group is automatically tracked wherein each asset is tagged, and at least one transport means are associated with at least one Proximate GPS (PGPS) location devices each equipped with a sensor which is receptive to the presence of a known asset. The sensor is able to detect the type of tag(s) associated with assets and associated with the transport means. The transport means transporting a PGPS device during the course of it activities passes by, associates with and/or may relocate a known tagged asset, the PGPS automatically detects the asset tag and stores the first sensed GPS location, asset tag ID, first time in a newly created PGPS record. When the transport means moves away from the asset by greater than a proximate distance set for the PGPS device reader the asset tag no longer is detected and the PGPS device recognizing such creates then adds to an asset transaction history log the previously stored last reading GPS location associated with the asset and last time of reading with associated details. The next time the PGPS is in communication with the PGPS host system the PGPS transaction history log of one or more transactions is transmitted to the host system providing the most recent asset location, associated transaction details and optionally specific relocation location path history for each asset in the transaction history log. Optionally the current location of the transport means can be mapped on the PGPS device in real-time together with the start and end locations of the asset, movement path and other associated information stored in the PGPS data base accessible independent of the host system availability.

### CROSS-REFERENCE TO RELATED APPLICATIONS

Provisional 60/962,280

### STATEMENT REGARDING FEDERALLY SPONSORED RESEARCH OR DEVELOPMENT

Not Applicable

### BACKGROUND OF THE INVENTION

1. Field of Invention

The present invention relates generally to the field of item tracking. More specifically, the present invention is related to designating items such as vehicles stored within a domain and the proximate tracking of these assets by devices carried by workers performing assigned non-tracking related tasks without requiring cognitive attention to scanning or requiring the devices have continuous wireless communication coverage.

2. Discussion of Prior Art

An asset, in the context of this application, is any asset that is deemed of value by a user. The asset herein noted can be any of, but not limited to, the following-a vehicle, container, mobile trailer, pallet, etc.

A simple tracking procedure utilized in organizations such as FedEx® or UPS® involves scanning barcodes attached to packages containing assets. Procedurally, the barcode on the package is first scanned before it leaves the premises of these organizations, and thereafter its location is recorded at various predetermined locations during its course of travel. Thus, the package is scanned only at pre-defined locations, based on a previously determined schedule. None of these prior art systems scan for the presence of the asset in a proximate location way by transport means performing non-scanning tasks (e.g. the above scanning is a conscious task assigned to track the asset).

Furthermore, prior art scenarios describe a group of several individuals sharing assets or resources that are of high value, but not so valuable that they must be constantly tracked or they are stored in a locked location. But, none of the prior art systems allow transport means working as part of a group to label (designate) asset resources for tracking and to track them in an proximate way as a by product of regularly assigned non-scanning work tasks such that the system will store that last known location of a asset and the last transport means to have been in proximate distance with it.

The following references describe prior art in the field of asset tracking, but none of them detail the present invention's method and system of designating and tracking assets by means of a proximate location transaction noting origin and destination locations and times of asset relocations by transport means performing its task.

U.S. Pat. No. 7,002,472 discloses a method of transporting cargo in a container via a transportation vehicle to a destination point, the method comprising: (a) loading the cargo in the container, the container including at least one container security detector for monitoring container security; (b) electronically sealing the container; (c) loading the container on the transportation vehicle; (d) transporting the cargo via the transportation vehicle; (e) continuously monitoring container security during transit using the at least one container security detector; (f) evaluating container security risk based on data collected while monitoring container security; (g) if the container security risk is high, taking corrective action; and (h) if the container security risk is not high: (i) proceeding to the destination point; and (ii) electronically unsealing the smart container.

U.S. Pat. No. 7,002,461 discloses a system for the automatic detection and identification of hidden aboveground fixed utility objects, comprising: a. at least one transponder located above ground, which is capable of being tagged to at least one utility object, for radio frequency communication with an radio frequency (RF) scanner/receiver, for communication with a control head; b. the RF scanner/receiver and control head being powered directly by a power source; wherein, the at least one transponder includes a radio frequency identification transponder that transmits information relating to the location of the hidden object; c. the RF scanner/receiver includes at least one antenna and an RF interrogator; and d. the control head includes at least one microprocessor and a user interface for automatically communicating the identification of the object; and e. the RF scanner/receiver and the control head are removably mounted on a mobile machine; thereby providing the operator of the machine an adequate alert about the identity and location of the object, without requiring operator interpretation when the machine comes in proximity of one of the at least one transponder and allowing an operator of the machine to avoid the at least one object tagged by the respective transponder.

U.S. Pat. No. 6,738,712 discloses a vehicle locating system that includes a hand-held remote unit associated with a user and a locator unit associated with a vehicle. The locator unit utilizes a GPS to store a location of the vehicle. The remote unit is selected from the group laptop computer, key ring, GPS watch, cellular telephone and PDA, and it utilizes a GPS to store a location of the user. The remote unit queries the locator unit to obtain the location of the vehicle, and then compares the location of the vehicle to its own location, whereupon the remote unit displays a direction for the user to travel in order to reach the vehicle.

U.S. Pat. No. 6,774,811 discloses a system for designation and opportunistic, unscheduled tracking of assets, using mobile wireless scanning devices; a tracking server capable of transferring information to and from the mobile wireless scanning devices; said mobile wireless scanning devices constantly scanning an area to opportunistically detect said valuable objects in an unscheduled manner, when detected transferring information, regarding the detected valuable object, including information about location and said unique identifiers whereby said objects of value are tracked in an unscheduled way by accessing said tracking server.

U.S. Pat. No. 6,097,301 discloses an RF identification system for identifying assets by communication between a RF transceiver, mounted on each asset, and a RF receiver. An interrogating receiver is mounted on the human operator.

U.S. Pat. No. 6,002,427 discloses a security system with proximity sensor to protect against unauthorized access to an electronic device. The security system is armed upon an input from the proximity sensor indicating departure of an authorized user from the vicinity of the electronic device.

U.S. Pat. No. 5,949,335 discloses a radio frequency identification (RFID) tagging system for network assets wherein a transponder tag attached to an asset in a computer network stores inventory data describing the asset.

U.S. Pat. No. 5,910,776 discloses a method and apparatus for identifying, locating, and monitoring equipment using a radio frequency identification transponder.

U.S. Pat. No. 5,844,482 discloses a tag monitoring system used for asset movement. The tags used in this system incorporate a motion sensor which detects asset movement and transmits this information to a central controller.

U.S. Pat. No. 5,708,423 discloses a data processing system that automatically maintains records of respective locations of a plurality of assets in real-time. Each of the assets has secured thereto a respective asset marker which transmits an identification signal that is unique to the respective asset. Each sensor device, installed at doorways of a building, receives the identification signal transmitted from the asset marker as the respective asset is moved through the doorway.

U.S. Pat. No. 5,319,364 discloses a passive keyless entry system which includes a portable beacon that is carried by an operator, and a receiver/controller located in the vehicle. The system is designed to lock the vehicle as the operator, carrying the beacon, moves away from the vehicle.

Whatever the precise merits, features and advantages of the above cited references, none of them achieves or fulfills the purposes of the present invention.

### SUMMARY OF THE INVENTION

The present invention provides for a system and method for tracking of an item with a group of individuals that may transport themselves or use transport means that carry detection devices. In the preferred embodiment of the invention, each asset is tagged and each member of a group carries a personal GPS (PGPS) device equipped with a sensor which recognizes the presence of known assets—the sensor being able to detect the type of tag(s) used by the group of individuals. Whenever a member of the group carrying a PGPS device is proximate to a known tagged asset, the system detects it and records the first detected location of the transport means associated with the PGPS, asset ID which can be associated with the PGPS equipment ID, in a newly created transaction entry stored in the PGPS device. During the relocation or association by the transport means with the asset the tag continues to be detected for a period of time. When the worker completes the task or tasks associated with the asset such as moving to a second location within the geographic area, a subsequent location is determined by the PGPS device triggered by said asset is no longer identified by the PGPS using the last known location and time stored for the asset while being detected and the completed transaction is saved in a Current Event Log file in the PGPS until such time as it can be sent to the host system. Tags that are used in conjunction with this invention include, but are not limited to, active RFID tags, infrared tags and passive RFID tags. A key benefit to the preferred embodiment is that the PGPS device automatically creates transactions identifying the change condition, or confirming the prior recorded condition, of assets that become associated with the PGPS during the time a work is near an asset whether the PGPS is carried by the worker or on equipment associated with the worker performing their tasks.

A second key benefit to the preferred embodiment is that the PGPS device performs its functions whether in communications with the host by wireless means or whether the PGPS device is functioning in stand-alone mode of operation thus the entire domain containing the assets need not be wireless communications coverage enabled or should the wireless communication system fail the PGPS device continues to log relocation transactions, saving each until such time as communications with the host system can be reestablished. Another key benefit is that a worker using a PGPS device need not invest data entry time during the task or tasks associated with the asset, such as a work order to relocate the asset from location A to location B, and indeed the worker may be unaware of the data being collected by the PGPS device carried on their person or on mounted on equipment they are operating such as the case may be. Such unattended data capture speeds completion of assigned tasks by not requiring worker time for bar code reading as an example and since data is collected automatically based on the proximate location of the worker to the asset, failure by the worker to remember to capture asset identification data is avoided.

In a further embodiment, a real-time GPS worker location may be displayed on a PGPS map image together with other geo-specific information of value to the worker should they elect to use the PGPS device in support of their task or tasks such as initially finding an asset using the asset's last know position displayed on the PGPS device map such information found within the PGPS device's data base having been periodically distributed by the host system when in communications with each PGPS device.

### BRIEF DESCRIPTION OF THE DRAWINGS

FIGS. 1A and 1B illustrates the preferred embodiment of the present invention's system for proximate automatic tracking of assets.

FIG. 2 illustrates the present invention's method for identifying and logging assets.

FIGS. 3A, 3B and 3C illustrates the invention's method for automatically creating asset update transactions.

FIG. 4A, 4B illustrates the present invention's method of adding to the database and finding assets within the geographic area.

### DESCRIPTION OF THE PREFERRED EMBODIMENTS

For the purposes of this disclosure the term scanner shall be defined a sensing device for item and/or class level identification including such devices as barcode scanner, RFID reader, optical character recognition readers, material sensors, image capture devices and the like. While this invention is illustrated and described in a preferred embodiment, the invention may be produced in many different configurations, forms and materials. There is depicted in the drawings, and will herein be described in detail, a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the present invention.

Organizations managing periodically relocated assets often experience difficulty in tracking and locating assets when needed after a move. In the drive to improve worker efficiency and productivity time lost performing tracking tasks and wasted searching for misplaced assets is a serious problem. For example, this applies to new vehicle processing operations, auto dealerships, trucking and cargo freight yards, palletized inventory, large item storage in open areas, etc. It is necessary to track and locate all items either by automatic identification means or manual searches. To implement and sustain major asset tracking generally requires significant labor and time commitment in training, data capture, data maintenance, infrastructure investment and periodic missing asset searches.

The system of the present invention automatically creates and maintains a total asset location history as a byproduct of worker activities detecting where each asset was first located, and more importantly its new location if moved, and the identity of transport means that was last proximate to the asset by uniquely assembling automatically captured user, asset ID, time and location data gathered without worker action or even necessary awareness then reporting in transaction format to a central host when next in wireless or direct connection thus enabling total freedom to track and identify assets whether within wireless coverage or not.

Generally whenever an asset arrives on a system's geographic domain it is recorded by a worker as to its nature or linked to previously stored information by a standard identification code such as VIN for vehicles. At this time an association is made between the new to the domain asset and an automatic identification means such as passive or active RFID, Infrared tag, barcode or other identification method that results in a unique identifier for the asset being stored. Together with a generic location such as “inbound” storage or specific GPS location the data is added to a host system data base.

A PGPS wireless mobile device equipped with GPS and automatic identification interfaces is carried by each worker or integrated into a transport means as they perform their work on and/or relocate assets within the system. In the case of an active RFID tag the active RFID tag mobile reader is such that its sensitivity is attenuated to perform readings only from nearby or proximate active RFID tags though such active tag beacons can otherwise be received at distances of hundreds of feet.

The close by reading is a key step enabling the mobile reader to identify the time when the worker or transport means first approached the asset as well as the time when the worker or transport means departs. Combining the asset ID information with time first detected along with that location and time last detected along with that location data the mobile device can classify the event into at least three categories of value.

The first category is when the worker by reason of their work order assignment is associated with the asset for a period of time and the location changes greater than a minimum distance. This happens for example when a new vehicle is moved from one location in a large parking lot to another for service or to stage for outbound delivery shipping. The new location is vital to proper system operation and timely finding of the asset when next it is to be processed.

Key is that the worker performs only the relocation task in this example and is not required to scan or otherwise perform a non-relocation task in addition to relocating the vehicle thus saving time and money; with less chance for human error. The same applies when a fork lift that is PGPS enabled is used by an operator to relocate a pallet.

The second category of value is when the worker is associated with the asset for a period of time but the location does not change by more than a minimum distance, if at all. This happens when a work task is performed on the asset at its current location such as installing a minor accessory to a new vehicle. The current location is confirmed to the system automatically thus refreshing the vehicle history.

The third category of value is automatically assigned is when the worker is associated with the asset for a brief period of time such as when passing by an asset and only one automatic read is detected by the mobile RFID reader. In this instance the asset ID and location can be stored and sent forward to the host system, hereafter referred to as the Asset Tag Server in the preferred embodiment, to confirm the asset's current location. Again these transactions being automatically created as a byproduct of the worker performing their normal duties not involving asset identification and location determination.

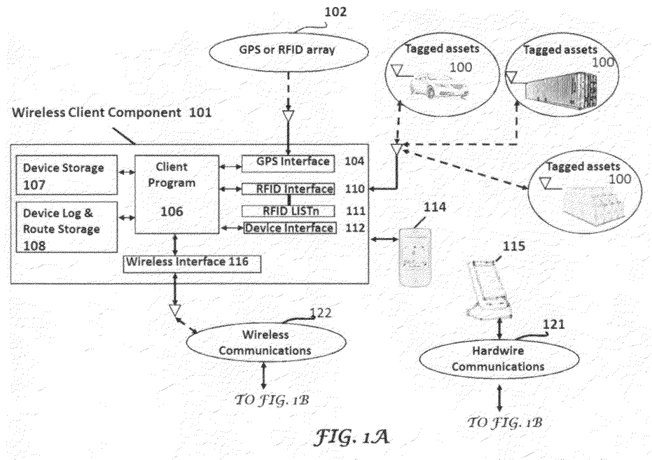

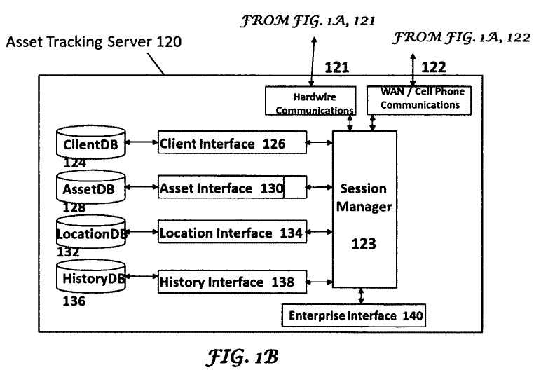

FIGS. 1A and B illustrates a preferred embodiment of the present invention's system for automatic proximate tracking of assets as a byproduct of normally performed worker duties. System components representative of the present invention's system for tagging and tracking an asset are discussed below:

Assets: Assets 100 are any objects that are of value to a client that need to be tagged and tracked as they are associated with the asset tracking system.

GPS: GPS 102 is the existing satellite-based global positioning system (GPS). In the present invention, GPS technology is used for asset location tracking. Tracking inside a building is accomplished by various methods, GPS when the building is single story and of certain construction that passes the satellite signals or by means of RFID tag sensors distributed throughout the site (each worker wears a RFID tag and each asset is tagged for proximate reading), triangulation, or other means known to those practicing the art.

Wireless Client Component: Wireless client component 101 is a PGPS device equipped with a user interface, a GPS interface, a sensor to detect asset tags, a direct connect interface to a home base 115 with recharging and USB capabilities, and an Internet, Cell phone, or other wireless WAN interface 116. The GPS aspect of the wireless client component may be implemented as part of PGPS device, such as, laptop computer, cell phone, personal digital assistant (PDA) or integrated in a car system having a wireless wide area network (WAN) connection for communicating with active calendar service. Wireless client component 101 includes a GPS interface for receiving location information. The responsibility of the wireless client component is to determine the location of the current user at two times, associating a first and second asset locations with first time detected and last time detected, and the asset ID then creating a transaction that is stored awaiting the next opportunity to transmit the location information to the asset tracking server (ATS) 120. In addition, wireless client component 101 will receive data from the ATS 120 and display it for the user on a display device. The GPS wireless client interface operates under the control of the respective client program. Client program 106 is responsible for the interaction between the sub-components of the wireless client component 101. It utilizes the incoming data, such as first and last detection location, their times, asset ID (detected via the RFID sensor interface 110), and wireless client component ID, and relays thus newly created transaction to the WAN or cell phone interface for transmission to the ATS system when such wireless means is available. The client program 106 also prepares the data for display on the GUI or a screen on the portable device such as a map display of the domain at worker selectable scales with worker data of interest identifying current worker location as well as one or more assets of interest in support of current worker tasking.

GPS Interface: GPS Interface 104 is implemented as a miniaturized GPS receiver that measures the time a radio signal needs from a GPS satellite in the GPS system until it arrives at the GPS antenna. By knowing the speed of the radio signal (the speed of light), and when each signal is transmitted, the distance to each satellite can be determined. The final solution of the equations produces an accurate position of the antenna (latitude, longitude, altitude). GPS interface 104 determines a current location of GPS wireless client component 101 and supplies the current location to client program 106 in support of the first and last detected asset locations.

WAN or Cell Phone Interface: WAN or cell phone interface 116 supports a wireless connection to the Internet or Intranet. With this interface, GPS wireless client component 101 is connected to the asset tracking server (ATS) and the Internet or the phone system network.

Input/Output Device: The output device 114 is implemented as a display of a wireless device and the input device as a touch screen or phone keyboard. The touch screen is used for manual user inputs and configuration. The display provides for output messages.

Asset Tracking Server: ATS component 120 is a web-based storage and retrieval system. One of the features of the system is that it automatically executes tasks. In this case, ATS 120 automatically identifies assets by their tags and maintains (e.g., in a database) a history of their locations, the clients PGPS device which detects them, the first and last times, and their associated locations.

Session Manager Session manager 123 is responsible for the communication and interaction between the internal components of ATS 120. Furthermore, it stores the PGPS originated transactions with that identify the worker, time first and last detection of the asset, asset ID and first and last detection locations for future uses.

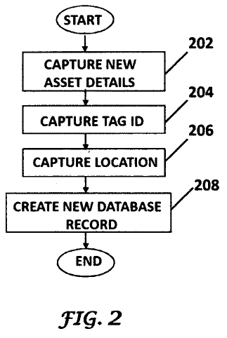

Session manager 123 of the ATS has updating and retrieval methods which communicate with the Client Interface 126, the Assets Interface 130, the Location Interface 134 and the History Interface 138. Session manager 123 also contains all of the logic to perform actions defined in the flowcharts (FIGS. 2-7). Session manager 123 sets the appropriate databases to record transaction information about detected assets. It is also responsible for creating new database entries when new assets are defined (created) in the system, and for removing entries if a valuable is removed from the system (and no longer being tracked). Session manager 123 also handles all queries or requests for information about the histories or last known locations of existing assets.

Client Database Client database 124 contains information about the workers in the system. Examples of client database 124 field definitions include (but are not limited to): primary key, worker name, worker ID number, other worker data fields (address, email, phone number, etc.).

Client Interface Client interface 126 contains the methods used by session manager 123 to access and modify the client description, tag ID, worker, etc.

Asset Interface Assets interface 130 contains the methods used by the Session Manager 123 to access and modify assets database 128. Examples of assets database 128 field definitions include (but are not limited to): asset automatic identification (ref. to as asset primary key), asset external name such as VIN (ref. to as asset secondary key), (other information about a particular asset such as date entering and exiting the system, link to associated data, etc).

Location(s) Database: Locations database 132 contains information about the current location of assets, and other system resources. Session manager 123 will access this database, for example, to determine the location of an asset upon request such as in the creation of a work order. Examples of location database 132 field definitions include (but are not limited to): primary key, foreign key to asset, foreign key to worker/client (last to be near the asset), coordinates X, Y (and optionally Z) of last known location of last detected automatic reading, time last detected automatic reading, etc.

Location Interface Location interface 134 contains the methods used by the session manager to access and modify locations database 132 as well as mapping the assets on an Asset Tracking Server 120 graphical display.

History Database History database 136 contains information about the asset movement history by the system.

FIG. 2 illustrates the present invention's method for identifying and logging assets 100 to a local data base 107 in the wireless client component 101. First, a worker recognizes an item 100 arriving at the facility and captures the details such as VIN or Body Number for a vehicle as well as associated data such as damage observed 202. Then, the asset 100 is assigned identification in the form of a tag ID 204. Next, the asset 100 is detected, and its initial location and time of detection are recorded 206 by reading the tag ID 204. The data captured is added to the database 208 in the form of a new record or if the tag ID 204 is being recycled the old record data are replaced by the new.

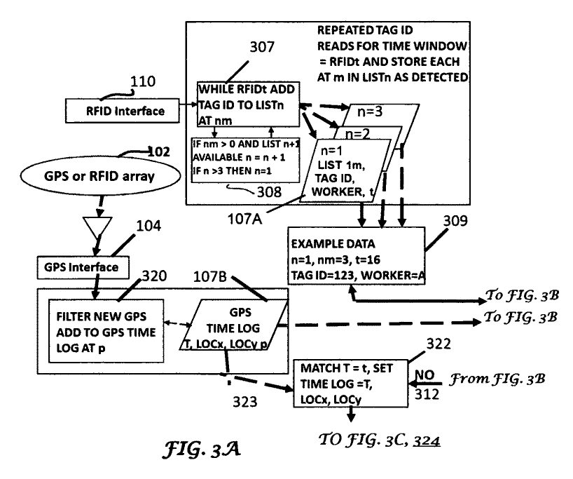

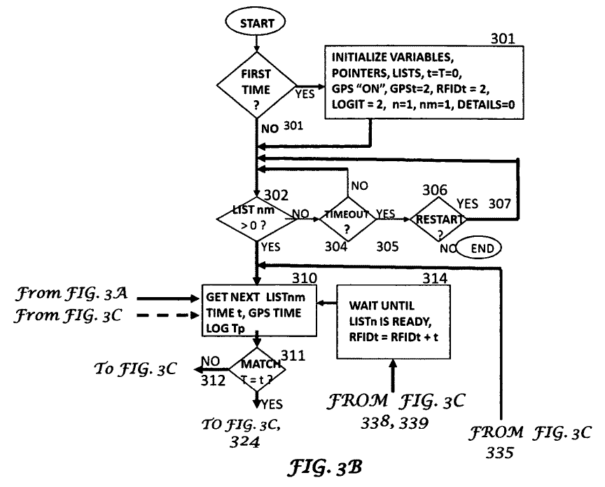

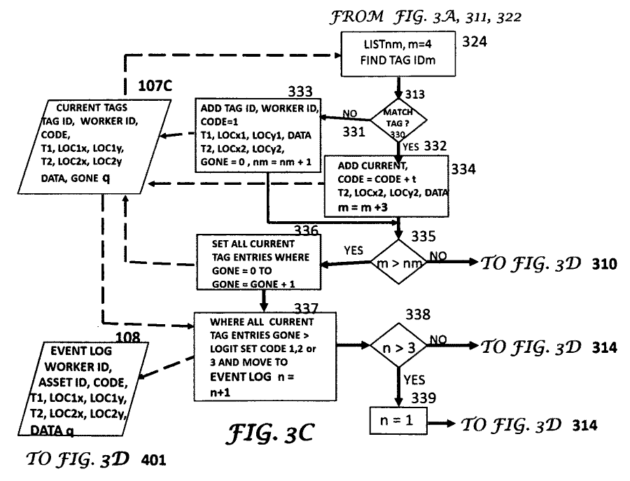

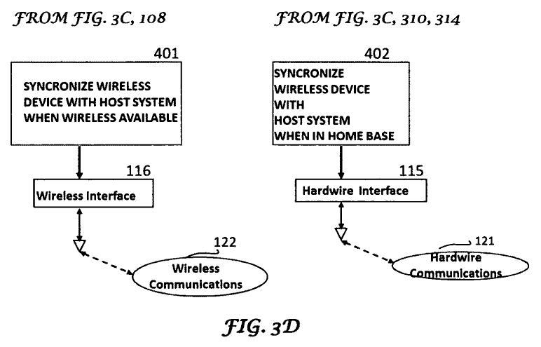

FIGS. 3A, 3B, 3C and 3D collectively illustrates the method of the present invention for transaction oriented proximate position unattended tracking of asset movements. Two concurrent data capture processes are active and when their respective data are combined the resultant transactions yield the information. The first concurrent process is the periodic capture of worker location through a GPS interface 104 in the form of GPS latitude and longitude, with optional altitude where needed, associated with a relative time T synchronized with the asset tag ID concurrent process. The second concurrent process is the capture of tag ID data through the RFID interface 110 associated with assets 100 in the domain of interest together with a relative time t synchronized with the GPS concurrent process. Each concurrent process will next be described in detail individually and then collectively identifying how the two discrete data streams are integrated to form at least three distinct types of asset tracking transactions detailing the asset's location history with automatic transaction code assignment to each recorded event.

There are at least three transaction codes saved in the Event Log 108. While traveling to an assigned asset location a worker carrying a PGPS wireless device will momentarily be near a number of assets not of interest to their work assignment however the PGPS duly notes the location and tag ID together with the first and last detected times of each tag ID. Recognizing from the data that the worker neither pause by the asset nor took time to relocate the asset a CODE=1 is associated with the passing by Event. The utility of this transaction is that the Asset Tag Server 120 obtains periodic confirmation of asset locations as a byproduct of normal work order activities without any worker cognitive attention to the data capture.

The CODE=2 transaction automatically created by the PGPS wireless device occurs when the worker arrives at the designated asset, confirmed by reading the tag ID for the target asset, and remains at the location greater than some minimum time and the designated asset's location does not change by more than some minimum distance set for the tracking system. In this case some task or tasks are being performed on or with the asset the fact of which is sent to the Asset Tag Server 120 to update the asset record. The utility of this transaction is that knowing the nature of the work order task(s) an analysis can be performed in real-time or post event to compare the performance of the worker at the asset site against average or standard performance guidelines without any worker cognitive attention to the data capture. In certain cases an alert or alarm can be automatically issued when deviation from standard time expected does not match PGPS generated transaction detail.

The CODE=3 transaction automatically created by the PGPS wireless device is when the worker arrives at the designated asset, confirmed by reading the tag ID for the target asset, and remains close to the asset for a period of time greater than some minimum time and the designated asset's location changes by more than some minimum distance set for the system. This combination of data occurs when an asset is relocated. The utility of this transaction is that the asset's relocation is automatically tracked and the Asset Tag Server 120 is updated with the new location as well as associated data including an optional detailed travel path of the asset from the point of pickup to drop off without any worker cognitive attention to the data capture. With the above end result perspective in place the disclosure of a preferred embodiment commences.

The RFID interface 110 captures and stores tag ID data, if any detected, where said tagged asset 100 is or are proximate to the worker during a predefined time window t such as 2 seconds (e.g., first time window is 0 second through 2 seconds). As the next time window t+1 commences (e.g., 2 seconds through 4 seconds) the data storage process 307 stores the time t data captured 107A in the first of three round robin memory list n=1, 2 and 3. This preferred embodiment treats the RFID interface 110 and its tag ID capture process as functioning concurrent and independent of the PGPS wireless device's data storage process thus enabling a continuum of t, t+1, t+2, etc. time windows without loss of a tag ID read.

The RFID interface 110 capture cycle repeats for the immediately following predefined time window t+1 in parallel with the PGPS wireless device storing the data in the next available memory list n+1. The utility of the data storage 107A method disclosed is such that while one list is being filled during time window t a previously filled list is being emptied by another concurrent process 310. As someone skilled in the art will recognize the round robin list fill/empty process could be implemented by a two list method but to allow for possible momentary overload in either the fill or empty processes a third buffer list is incorporated in the preferred embodiment.

The example three Lists 107A are referenced as LISTn where n=1, 2 and 3 with each list having its own current pointer for last record of m such that at all times the number of entries in a list is known by the value of LIST(nm) together with stored data 309. The lists are filled and emptied as an on-going process with each list in turn being filled then emptied 310 in concert with the GPS Time Log 107B as described next.

The GPS Time Log 107B is created and maintained as a concurrent process utilizing the GPS interface 104 to receive worker location data first being filtered 320 then stored with its associated time T. The filtering process 320 takes into consideration the reasonableness of the data vis a vis prior data and worker environment. At times a GPS reading will be influenced by transitory events such as an aircraft between the satellite source of the signal 102 and the GPS receiver 104 causing an errant position reading that indicates a remote location not physically possible. As such the filter process 320 tracks immediate prior location data and computes the distance to the new location. When the distance exceeds a realistic value for the application a place holder new location is inserted based on prior data. Once the next location is determined at T+1 the placeholder location can be updated to reflect the new location data.

After start up 301 and determining that there is some Tag ID data in the first list 107A the process 302 the first entry in the first list is fetched 310 from LIST(1 m) 107A where m=1. As part of the same process 310 the corresponding GPS location data is retrieved from the GPS Time Log 107B and matched 311 to confirm that T matches to the time window of t (e.g., 0 to 2 seconds in the prior example). When the T and t time values do not match then a match is found 322 in the GPS TINE Log 107B the matching T GPS data made available 324 to create and update the Current Tags list 107C.

As illustrated in 324 from LIST(n4) the Tag ID is used to search the Current Tag list 107C to determine if this Tag ID has been detected during an earlier time window t. If no match 330 then the Tag ID is added 333 to the Current Tag list 107C by storing the Tag ID, Worker ID, Code=1, T1, LOCx1, LOCy1, Data (if any) or null while providing a destination set of data T2, LOCx1, LOCy1, GONE=0 as place holders for the moment. The LIST(n) value for m is also incremented then tested 335 against the list count m. If there are more data to process from the LIST(n) then return to 310 to do so. If the last data has been processed for the Tag ID reading time window t then a check is made 336 to see if any previous Tag ID entries in the Current Tag list 107C remain not updated and when any such are found 336 GONE is incremented by 1 to so indicate for future reference.

LOGIT is a value that determines how many cycles of not reading a Tag ID shall pass before that record is moved from the Current Tag list 107C to the Event Log 108. By setting a LOGIT counter during first time initialization 301 and comparing 337 Tag ID entries in the Current Tag list 107C entries ready to be moved to the Event Log 108 are identified and moved 337. By this method only those Tag ID entries that are regularly updated remain in the Current Tag list 107C thus enabling a long duration of worker and Tag ID association to be identified and recorded as each LIST(n) is processed until such time as each Tag ID is determined to be ready 337 to move to the Event Log 108.

Having completed the move process 337 the data in LIST(n) 107A has been fully processed so the space can be released and the next available LIST(n+1) processed as above. A check is made 336 to see if the next n value is greater than 3 and if so n is reset 339 to the value of 1. The next step then is to wait 314 until the next LISTn is ready. A FLAG field as the first data in each LISTn is set to 1 when there is data to process and 0 when LISTn can be used by 307 or is being used by 310 thus preventing conflicting LISTn uses.

By the preferred method disclosed above an Event Log 108 is created and made ready for wireless transfer 122 to synchronize 401 with the Asset Tag Server 120 for storage and updating of associated tables. Likewise the Event Log 108 can be transferred to the Asset Tag Server 120 by a hardwire transfer 121 method to synchronize 402 in a similar manner.

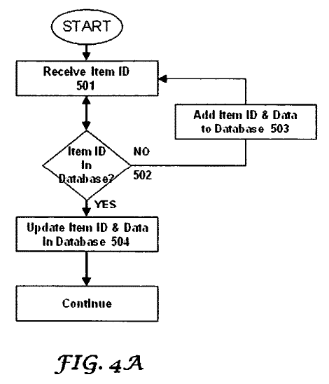

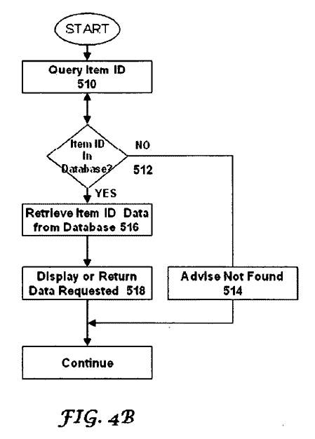

FIG. 4A illustrates the present invention's method for receiving and storing new items to the data base enabling updating from time to time and FIG. 4B illustrates the present invention's method for query of and item ID and subsequent retrieval and display of data stored in the data base, if the item ID is found.

Thus, the present invention provides for a system and a method for tracking of an item by a group of workers performing their non-tracking tasks who may either transport themselves or use a transport means that carries a wireless detection device such that when proximate to a known tagged asset, the system detects it and records the first and last detected locations and time then utilizing a set of business rules creates, edits for accuracy and classifies an event transaction in near real-time used to update first the wireless detection device data base then when in contact updates the host system. Further the wireless detection device can display the transport means and the asset on a digital map enabling a more efficient completion of work order assignments. Furthermore, the present invention is superior to any of the prior art systems described, because the asset location is automatically updated without cognitive action related to location of the asset. Also, the present invention the wireless detection device functions whether or not it is in wireless communications with the host system.

The above enhancements for a system for proximate tracking of assets and its described functional elements are implemented in various computing environments. For example, the present invention may be implemented on a hand held PDA linking either wirelessly or by direct connection to a host system via a multi-nodal system (e.g. LAN) or networking system (e.g. Internet, WWW, wireless web). All programming, GUIs, display panels and dialog box templates, and data related thereto are stored in computer memory, static or dynamic, and may be retrieved by the user in any of: conventional computer storage, display (i.e. CRT) and/or hardcopy (i.e. printed) formats. The programming of the present invention may be implemented by one of skill in the art of communications, database or object-oriented programming.

### CONCLUSION

A system and method has been shown in the above embodiments for the effective implementation of designating and tracking assets in a proximate manner integrating location and asset ID along a shared timeline to enable creation of transactions that update a data base enabling query and work order processing about and on said assets. While various preferred embodiments have been shown and described, it will be understood that there is no intent to limit the invention by such disclosure, but rather, it is intended to cover all modifications and alternate constructions falling within the spirit and scope of the invention, as defined in the appended claims. For example, the present invention should not be limited by software/program, computing environment, or specific computing hardware.

What is claimed is:

1. A system for proximate tracking of assets, said system comprising:
at least one item, each with an identification means thereon,
at least one mobile transport means used when performing assigned tasks that periodically move where said items are located within a geographic area;
at least one mobile wireless scanning device, transported by said mobile transport means, that may or may not be in communication with a host system at all times, each of said mobile wireless scanning devices having a unique identifier;
said mobile wireless scanning device at times being proximate to an item detecting said item identification means automatically while said mobile transport means is proximate to said item, and in the instance said item is detected, said mobile wireless devices storing first location detected and subsequently a second location where last detected thereafter creating a transaction detail based on a set of rules, storing the said rule based transaction details on the mobile wireless device and transferring said transaction details to the host system when in communications with the said host system, regarding the detected item, including first location detected and second location where last detected, times for first and last detecting an item tag and said unique identifier together with additional reference data of interest, to said host system;
said host system capable of transferring information to and from said at least one mobile wireless scanning devices when in communications with mobile wireless scanning devices;
whereby said item locations and relocations are tracked while each mobile transport means moves about within the geographic area undertaking assigned tasks, which may involve relocating said items, without requiring cognitive action on the part of the mobile transport means itself to capture and report said item location transaction data to the host system.

2. A system for proximate tracking of assets of claim 1, wherein at least one item receives an identification means thereon, said identification means comprises any of the following: active RFID tag, passive RFID tag, infrared tag or other automatic identification method.

3. A system for proximate tracking of assets of claim 1, wherein at least one item receives an identification means thereon, wherein said information about location is obtained using at least a global positioning system (GPS) system as available or alternatively a local location network such as fixed position location array.

4. A system for proximate tracking of assets of claim 1, wherein at least one item receives an identification means thereon, wherein said mobile wireless scanning devices is implemented in any of the following devices: laptop computer, mobile computer, wireless telephone, personal digital assistant, integrated communications device, or integrated with a transport means movement system having at least periodic wireless wide area network (WAN) connectivity within the domain containing the items.

5. A system for proximate tracking of assets of claim 1, wherein at least one item receives an identification means thereon, wherein said information regarding tagged items, including information about locations and times for first and last detected and said unique identifiers, is transmitted to said host system over any of the following networks: Internet, wide area network (WAN), local area network (LAN), a wireless network or by direct connections when the mobile wireless device is in its home base.

6. A system for proximate tracking of assets of claim 1, wherein at least one item receives an identification means thereon, wherein said mobile wireless scanning device further comprises: a sensor interface, said sensor interface detecting said items; a positioning interface, said positioning interface identifying said location of said mobile wireless scanning device; a wireless interface, said wireless interface transferring information regarding said detected items, including information about said first and last detected locations and said unique identifiers, to and from said host system when in communications; a graphical user interface (GUI) interface, said GUI interface displaying said information regarding items information about said first and last detected locations stored when initially no longer detecting the tag, and said unique identifiers; resident data storage for holding data captured and computed until sent forward; power reservoir providing power to operate the wireless mobile device, and a client program, said client program managing interaction between each of said interfaces.

7. A system for proximate tracking of assets of claim 1, wherein at least one items receive an identification means thereon, wherein said host system further comprises: a wireless interface, said wireless interface receiving said information regarding items, including information about first and last detected locations and said unique identifiers, from said at least one mobile wireless scanning devices; a session manager program, said session manager program updating an item location data base using said information received by said wireless interface, and at least one interfaces, said at least one interfaces linking said session manager program to at least one databases storing information about said items and said transport means.

8. A system for proximate tracking of assets of claim 7, wherein at least one item receives an identification means thereon, wherein said client information is stored in a client database, which is accessed by said session manager program via a wireless mobile device interface.

9. A system for proximate tracking of items of claim 7, wherein at least one item receives an identification means thereon, wherein said information regarding said item is stored in a item database, which is accessed by said session manager program via a items database interface.

10. A system for proximate tracking of assets of claim 7, wherein at least one item receives an identification means thereon, wherein said information regarding said location of said item is stored in a location database, which is accessed by said session manager program via a location interface.

11. A system for proximate tracking of assets of claim 7, wherein at least one item receives an identification means thereon, wherein information regarding status of said item is stored in a history database, which is accessed by said session manager program via a history interface.

12. A system for proximate tracking of items of claim 1, wherein at least one item receives an identification means thereon, wherein said identification means incorporates a GPS location means providing the mobile wireless device integrated identification and location data with a shared timeline reference.

13. A system for proximate tracking of items of claim 12, wherein at least one item receives an identification means thereon, wherein said identification means receives GPS locations data by a Bluetooth enabled GPS means.

14. A method for proximate tracking of assets, wherein at least one item receives an identification means thereon, said method comprising: periodically sensing an area for items via a mobile wireless scanning device, each of said mobile wireless scanning devices having a unique identifier; said mobile wireless scanning device detecting a item in said scanned area while its transport means perform its assigned tasks, said scanning performed in an automatic manner not requiring the attention of its transport means for scanning action; said mobile wireless scanning device determining and recording first tag location noted and subsequent second being last detected location stored when initially no longer detecting the tag, thereafter creating a transaction, storing a transaction and transferring information of said detected item relocation, if any; updating information regarding said detected item, including information about recording first location and subsequently a second location when last detecting the tag and said unique identifiers, in a host system; and outputting graphically said information regarding said detected item information on a resident mobile wireless scanning device that may include an optional map display means.

15. The method for proximate tracking of assets of claim 14, wherein at least one item receives an identification means thereon, wherein said tag comprises any of the following: active RFID tag, passive RFID tag, infrared tag or other automatic identification method.

16. The method for proximate tracking of assets of claim 14, wherein at least one item receives an identification means thereon, wherein said location of said detected item is obtained using at least a global positioning system (GPS) system as available or alternatively a local location network such as fixed position location array.

17. The method for proximate tracking of assets of claim 14, wherein at least one item receives an identification means thereon, wherein said mobile wireless scanning devices is implemented in any of the following devices: laptop computer, mobile computer, wireless telephone, personal digital assistant, integrated communications device, or a transport means movement system having at least periodic wireless wide area network (WAN) connectivity within the domain containing the items.

18. The method for proximate tracking of assets of claim 14, wherein at least one item receives an identification means thereon, wherein said information regarding tagged items, including information about first location noted and subsequent second being last detected location stored, therefor creating a transaction, storing a transaction with said unique identifiers, is transmitted to said host system over any of the following networks: Internet, wide area network (WAN), local area network (LAN), or a wireless network or by direct connections when the mobile device is in its home base.

19. A method for finding a item by utilizing information stored in a database regarding previously tracked instances of tagged items in the geographic area, said tagged items proximately tracked while mobile transport means perform its tasks using at least one mobile wireless scanning device, each having an unique identification, said method comprising the steps of: identifying said item to be located in the geographic area; querying said database for said identified item; receiving at least said last recorded no longer sensed location used to locate said identified item.

20. The method for finding a item by utilizing information stored in a database regarding previously tracked instances of tagged items of claim 19, said tagged items tracked using at least one mobile wireless scanning devices, each having an unique identification, wherein said identified item to be located is displayed by means of map display operating as part of the mobile wireless scanning device independent of the host system, or on the host system or both.

21. The method for finding a item by utilizing information stored in a database regarding previously tracked instances of tagged items of claim 19, said tagged items tracked using at least one mobile wireless scanning devices, each having an unique identification, wherein identification means on said identified items comprises any of the following: active RFID tag, passive RFID tag, infrared tag or other automatic identification method.

22. The method for finding a item by utilizing information stored in a database regarding previously tracked instances of tagged items of claim 19, said tagged items tracked using at least one mobile wireless scanning devices, each having an unique identification, wherein said database is accessed over a network.

23. The method for finding a item by utilizing information stored in a database regarding previously tracked instances of tagged items of claim 22, said tagged items tracked using at least one mobile wireless scanning devices, each having an unique identification, wherein said network comprises any of the following: local area network (LAN), wide area network (WAN), wireless network, HTTP protocol-based networks, or Internet or by direct connections when the mobile device is in its home base.

24. A method for identifying items from a set of at least one item and logging information regarding said items in a database, said method comprising the steps of: proximately identifying an item from said set of at least one items while transport means perform its tasks carrying mobile wireless scanning devices; recording a time and location of detection associated with when said item is first identified and a the subsequent time and location when said item is no longer detected; tagging said identified item; assigning a unique tag identification to said tagged item; detecting first identified location and a subsequent second being last detected location stored when initially no longer detecting the tag, and creating a entry in said database with information about said identified item, including said unique tag identification, said detected first time and location identified and a the subsequent time and location when said item is no longer detected, said times of detection and loss of detection, and said unique transport means identification.

25. The method for identifying items from a set of at least one items and logging information regarding said items in a database of claim 24, wherein tags in said tagged items comprises any of the following: active RFID tag, passive RFID tag, infrared tag or other automatic identification method.

26. The method for identifying items from a set of at least one items and logging information regarding said items in a database of claim 24, wherein said step of detecting a location is accomplished using at least a global positioning system (GPS) as available or alternatively a local location network such as fixed position location array.

27. The method for identifying items from a set of at least one items and logging information regarding said items in a database of claim 26, wherein said network comprises any of the following: local area network (LAN), wide area network (WAN), wireless network, HTTP protocol-based networks, or Internet.

28. The method for identifying items from a set of at least one items and logging information regarding said items in a database of claim 24, wherein said database is accessed over a network.
